(19) United States
(12) Patent Application Publication
(10) Pub. No.: US 2015/0178445 A1
(43) Pub. Date: Jun. 25, 2015

(54) DETECTING VARIANTS IN SEQUENCING DATA AND BENCHMARKING

(71) Applicant: THE BROAD INSTITUTE, INC., Cambridge, MA (US)

(72) Inventors: Kristian CIBULSKIS, Somerville, MA (US); Gad GETZ, Belmont, MA (US); Michael LAWRENCE, Cambridge, MA (US)

(21) Appl. No.: 14/633,321

(22) Filed: Feb. 27, 2015

Related U.S. Application Data
(63) Continuation-in-part of application No. PCT/US2013/057128, filed on Aug. 28, 2013.
(60) Provisional application No. 61/693,987, filed on Aug. 28, 2012.
(60) Provisional application No. 61/762,694, filed on Feb. 8, 2013.

(51) Int. Cl. G06F 19/22

(52) U.S. Cl. CPC G06F 19/22

(57) ABSTRACT

A system, method, and computer program product for detecting variants from sequencing data. Aligned sequencing data can be provided and filters can be applied to the aligned sequencing data. The filtered data can be used as input, and a first classifier can be applied to determine if any alteration is present beyond an expected threshold due to a sequencing error and candidate variants can be identified. The identified candidate variants can be passed through additional filters to remove false positives. A somatic status of the filtered candidate variants can be determined using a second classifier. The related apparatus, systems, techniques and articles are also described.

### RELATED APPLICATIONS AND INCORPORATION BY REFERENCE

This application is a continuation-in-part application of international patent application Serial No. PCT/US2013/057128 filed 28 Aug. 2013, which published as PCT Publication No. WO 2014/036167 on 6 Mar. 2014, which claims benefit of US provisional patent application Ser. No. 61/693,987 filed 28 Aug. 2012 and 61/762,694 filed 8 Feb. 2013.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### FEDERAL FUNDING LEGEND

The present subject matter was made with government support under HHSN261201000055C awarded by the Department of Health and Human Services, U54CA143845 awarded by National Institutes of Health, and U54HG003067 awarded by the National Institutes of Health. The government has certain rights in the present subject matter.

### FIELD OF THE INVENTION

This disclosure relates generally to sequencing data processing and benchmarking, and in particular, to detecting variants in sequencing data.

### BACKGROUND OF THE INVENTION

Cancer is a disease of the genome wherein somatic genetic alterations transform normal cells into malignant cells. Detecting, cataloguing and interpreting these somatic events are at the core of a rapidly increasing number of cancer genome projects such as The Cancer Genome Atlas (TCGA) and the International Cancer Genome Consortium (ICGC), which involve thousands of cases harboring millions of mutations. As sequencing moves from research into clinical use, for example, as a tool for diagnostic, even more cases will need to be characterized.

Somatic single-nucleotide substitutions are an important and common mechanism for altering gene function in cancer. Yet, they are challenging to identify. First, they occur at a very low frequency in the genome, ranging from 0.1 to 100 mutations per megabase, depending on tumor type. Second, the alterations may be present only in a small fraction of the DNA molecules originating from the specific genomic locus. The reasons include contamination of cancer cells with surrounding stromal cells; local copy-number variation within the cancer genome; and presence of a mutation within only a sub-population of the tumor cells (‘subclonality’). The fraction of DNA harboring an alteration (‘allelic fraction’) has been reported to be as low as 0.05 for highly impure tumors. Consequently, a mutation calling method must be highly sensitive to somatic mutations with very low allelic fractions (i.e. fraction of sequencing reads that support the mutation).

While having high sensitivity, a detection method must also have high specificity so as not to be overwhelmed by false positive results. Although false positives can be controlled through subsequent experimental validation, this is an expensive and time consuming step that is impractical for general application. In view of the above, there is a need for a method with high and predictable specificity, so that experimental validation can be applied sparingly.

The sensitivity and specificity of any somatic mutation caller varies along the genome. They depend on factors including, for example, depth of sequence coverage in the tumor and normal; the local sequencing error rate; the allelic fraction of the mutation; and the evidence thresholds used to declare a mutation. Understanding how sensitivity and specificity depend on these factors is necessary for designing experiments with adequate power to detect mutations at a given allelic fraction, as well as for inferring the mutation frequency along the genome, which is a key parameter for understanding mutational processes and significance analysis.

Citation or identification of any document in this application is not an admission that such document is available as prior art to the present invention.

### SUMMARY OF THE INVENTION

In some implementations, the current subject matter relates to a computer-implemented method. The method can include receiving aligned sequencing data; applying one or more filters to the aligned sequencing data; using the filtered data as input, applying a first classifier to determine if any alteration is present beyond an expected threshold due to a sequencing error and identifying one or more candidate variants; passing the one or more identified candidate variants through one or more additional filters to remove one or more false positives; and determining a somatic status of the one or more filtered candidate variants using a second classifier. At least one of the above can be performed on at least one processor. The sequencing data may include DNA sequencing or RNA sequencing data. The one or more variants are mutations, point mutations, somatic point mutations, or germline point mutations. In some implementations, the one or more false positives are created by correlated sequencing noise. In some implementations, a Panel of Normals is used to identify one or more false positives. At least one of the first and second classifiers can be a Bayesian classifier.

In some implementations, the one or more filters include a proximal gap filter which rejects variants with neighboring insertion and/or deletion events. In some implementations, the one or more filters include a poor mapping region filter which rejects sites having a determined mapping quality score of zero. In some implementations, the one or more filters include a clustered position filter which looks for correlation in the position of mutant alleles within their reads. In some implementations, the one or more filters include a strand bias filter which rejects sites where a distribution of strand observations of mutant allele is biased compared to the allele of the reference genome. In some implementations, the one or more filters include a triallelic site filter which excludes sites each having at least three alleles beyond what is expected by sequencing error. In some implementations, the one or more filters include an observed in control filter which uses sequencing data from a matched normal as control data to eliminate sites where the reference genome has evidence of mutant allele.

In some implementations of the current subject matter, a system for detecting one or more variants from sequencing data is provided. The system can include means for receiving aligned sequencing data; means for applying one or more filters to the aligned sequencing data; means for using the filtered data as input, applying a first classifier to determine if any alteration is present beyond an expected threshold due to a sequencing error and identifying one or more candidate variants; means for passing the one or more identified candidate variants through one or more additional filters to remove one or more false positives; and means for determining a somatic status of the one or more filtered candidate variants using a second classifier.

In some implementations, a method for benchmarking performance of variant detection. The method includes providing variants that were discovered in deep-coverage data sets; down-sampling by randomly excluding a subset of reads of the data set at sites of known validated variants; repeating the down-sampling one or more times and estimating a sensitivity as a fraction of the times the known variants are detected. At least one of the above is performed by at least one data processor.

In some implementations, a method for benchmarking performance of variant detection is provided. The method includes creating a normal virtual tumor that has no true variants; providing sequence data from a single normal sample; assigning reads of the sequence data to be either “tumor” or “normal” to a desired depth; and measuring specificity by comparing the normal virtual tumor against the sequence data. At least one of the above is performed by at least one data processor.

Articles of manufacture are also described that may comprise computer executable instructions permanently stored on non-transitory computer readable media, which, when executed by a computer, causes the computer to perform operations herein. Similarly, computer systems are also described that may include a processor and a memory coupled to the processor. The memory may temporarily or permanently store one or more programs that cause the processor to perform one or more of the operations described herein. In addition, operations specified by methods described herein can be implemented by one or more data processors either within a single computing system or distributed among two or more computing systems.

The subject matter described herein provides many advantages. For example, to meet the needs of detecting, cataloguing, and interpreting somatic events, the present subject matter provides a novel somatic point mutation caller, which we call “MuTect,” is believed to be superior to prior methods in terms of sensitivity, particularly for low allelic fraction events, while remaining highly specific. This uniquely positions the method to deeply explore the mutational landscape of highly impure tumor samples, as well as the subclones with a tumor. The ability to characterize these subclonal events is not only critical to understanding tumor evolution both in disease progression and response to treatment, but also as a clinical diagnostic for personalized cancer therapy.

A differentiator of the current subject matter allowing it to be sensitive to low allele fraction mutations is the explicit modeling of alternate alleles at any frequency, whereas alternative methods typically assume heterozygous genotypes as the basis for their calculations.

Furthermore, many mutation detection methods are being developed today, but there are few systematic approaches for benchmarking their performance on real sequencing data (Online Methods). Previous publications described simulation methods ranging from fully synthetic models to ones that better capture real sequencing error. However, none of these methods model the full diversity of non-random sequencing errors of both the reference and alternate alleles at the genomic site. To better evaluate the performance of mutation detection methods, two novel benchmarking approaches are also provided herein:
(1) Down-sampling. This approach involves studying somatic mutations that were discovered in deep-coverage cancer data sets and then experimentally validated, to see if these “gold-standard” mutations would have been found with lower coverage. Down-sampling can be accomplished, for example, by randomly excluding a subset of the reads at the sites of these validated mutations. For depths of coverage from 5× to 50× in the tumor and normal, the down-sampling procedure can be performed repeatedly and the sensitivity can be estimated as the fraction of times the known mutation is detected. Notably, down-sampling preserves the expected allelic fraction of the original mutation, because reads are removed regardless whether or not they contain the alternate allele.
The down-sampling approach is limited in three respects:
   (i) the number of validated events is typically small, limiting the precision of the sensitivity estimate;
   (ii) the analysis excludes any mutations that were missed in the deep-coverage cancer data, which may overestimate the true sensitivity; and
   (iii) specificity cannot be measured in this manner, because one typically lacks a similar ‘gold-standard’ list of true negative sites.
(2) Virtual tumors. To address the issues related to down-sampling, a benchmarking procedure is provided herein that involves creating “virtual tumors” in which all true mutations are known with certainty (Online Methods). To create the virtual tumors, reads from deep coverage of, for example, either one or two samples are selected.

To measure specificity, a virtual tumor can be created that has no true mutations. Using sequence data from a single normal sample, the reads can be assigned to be either ‘tumor’ or ‘normal’ to a desired depth. By applying methods to this virtual tumor-normal pair, the specificity of the method can be easily measured because any somatic mutations identified are necessarily false positives.

To measure sensitivity, a virtual tumor can be created that has true mutations only at known sites. Starting with a virtual tumor-normal pair derived from a single normal sample (“A”) as above, mutations can be introduced by substituting reads from a second normal sample (“B”). Specifically, sites at which B contains heterozygous germline variants not found in A can be identified. Reads in the virtual tumor with variant-containing reads from B can be replaced, following a binomial distribution given a specified allelic fraction. One advantage of using germline events is that they are frequent (˜1000/Mb) and accurately detected, as they have often been genotyped by multiple technologies. In this manner, real sequencing data can be used to introduce somatic mutations within a virtual tumor to any desired depth and allelic fraction.

The two benchmarking approaches can be complementary: down-sampling uses real somatic mutations but is limited to previously detected and validated mutations, whereas the virtual tumor approach can generate a large datasets but reflects the distribution of events that occur in the germline.

The details of one or more variations of the subject matter described herein are set forth in the accompanying drawings and the description below. Other features and advantages of the subject matter described herein will be apparent from the description and drawings, and from the claims.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. Nothing herein is to be construed as a promise.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”. “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 is a process flow diagram illustrating an exemplary implementation of the present subject matter;

FIGS. 2a and 2b show sensitivity and specificity of results in accordance with some implementations of the present subject matter;

FIGS. 3a-3f show various results of specificity of somatic classification and variant detection using an exemplary implementation of the present subject matter;

FIGS. 4a-4d show comparisons of various benchmarks of implementations of the present subject matter against different detection methods; and

FIG. 5 is a process flow diagram illustrating an exemplary implementation of the present subject matter.

### DETAILED DESCRIPTION

The present subject matter is directed to the detection of variants, which include, for example, alterations, allelic variants, mutations and polymorphisms. The sequencing data may include, for example, DNA, RNA, cDNA, and/or other genetic sequencing data. Although systems, methods and computer program products for detection of somatic mutations in DNA sequencing data will be discussed in detail below, these are being provided as exemplary embodiments and one skilled in the art would recognize that the present subject matter can also be used for detection of other variants from other sequencing data.

Although many mutation detection methods have been developed, there are few systematic approaches for benchmarking their performance on real sequencing data. Previous publications described simulation methods ranging from fully synthetic models to ones that better capture real sequencing errors. However, none of those methods model the fully diversity of non-random sequencing errors of both the reference and alternate alleles at the genomic site. To better evaluate the performance of mutation detection methods, the present subject matter provide benchmarking approaches including down-sampling and virtual tumors.

In some implementations, down-sampling can use subsets of reads from primary sequencing data of validated somatic mutations to measure the sensitivity with which a mutation caller identifies the known mutations. Subsets can be generated by randomly excluding reads from the experimentally-derived data set until a desired depth of coverage is reached. Notably, down-sampling can preserve the expected allelic fraction of the original mutation because reads are removed regardless whether or not they contain the mutant allele. The down-sampling approach can potentially be limited in four respects: (i) the number of validated events is typically small, resulting in larger error bars for the sensitivity estimate; (ii) because allele fractions are preserved, only previously validated allele fractions can be explored; (iii) the analysis excludes any mutations that were not originally detected and hence may overestimate the true sensitivity; and (iv) specificity cannot be measured.

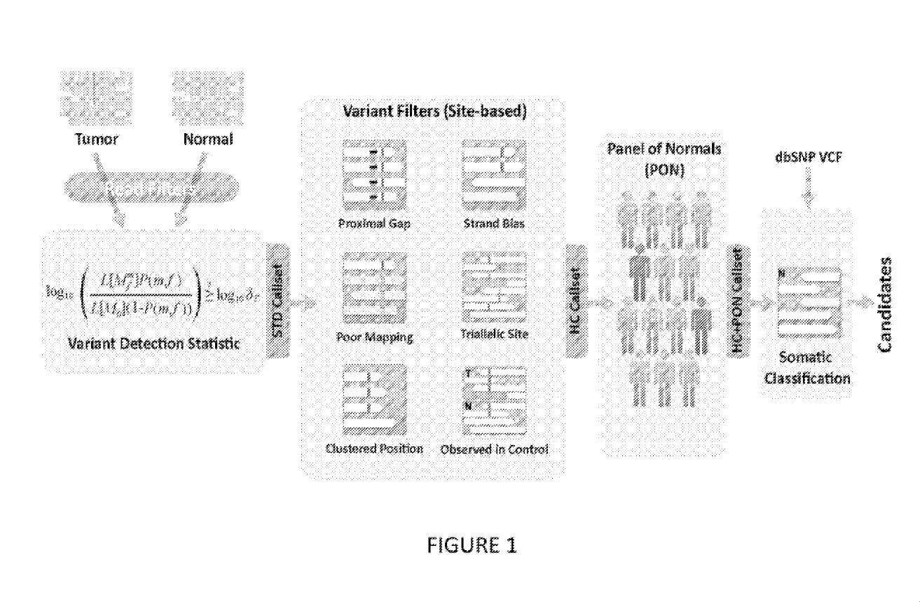

To address the issues with down-sampling, the present subject matter provides a benchmarking procedure that involves creating ‘virtual tumors’ in which all true mutations with certainty (Online Methods, FIG. 1) are known. In some implementations, to measure specificity, virtual tumors and normal can be created, at controlled depths, from sequencing data generated by two different sequencing experiments of the same normal sample (designated A). All mutations identified are necessarily false positives. To measure sensitivity, somatic mutations can be simulated at controlled allele fractions by replacing selected reads in the virtual tumor with reads from a second sample (designated B) at loci where sample A is reference and sample B harbors a high confidence germline heterozygous event. The ability of an algorithm to detect these simulated somatic mutations can then be assessed. In this manner, sensitivity can be measured using real sequencing data at a desired depth of coverage and allelic fraction.

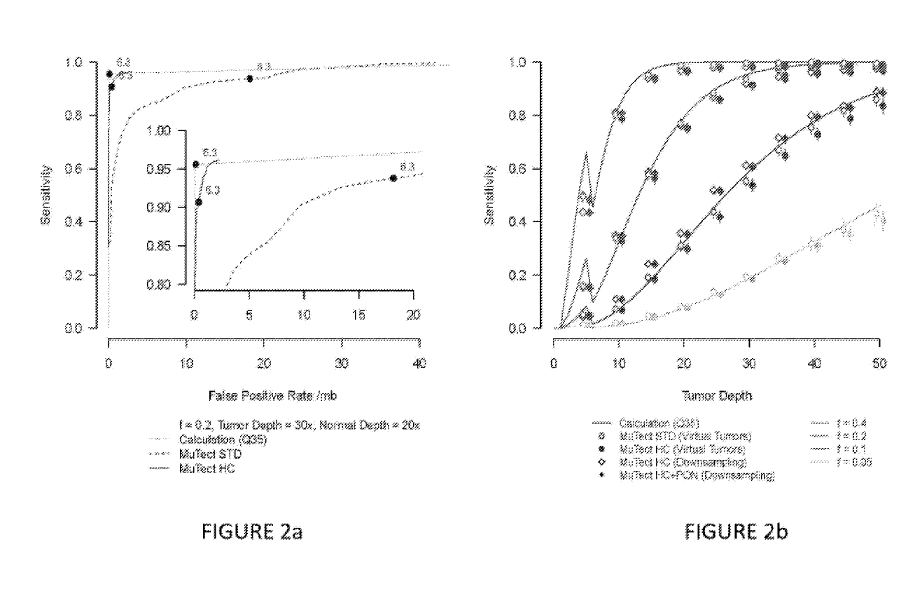

In some implementations, the two benchmarking approaches can be complementary. Down-sampling can use real somatic mutations, but can be limited in the parameter regimes it can explore, and it cannot measure specificity directly. In contrast, the virtual tumor approach does not have these limitations. However, it simulates somatic mutations using germline events, which differ from somatic mutations in their nucleotide substitution frequencies and context. As recalibrated base qualities vary for the different bases (owing to biases in machine errors), there is variable sensitivity to detect different substitutions (FIG. 2). Because the difference in sensitivity is minimal, all the germline events can be chosen. However, it is possible with the virtual tumor approach to simulate the mutation spectrum of a specific tumor type by reweighting the germline events to match the expected mutation spectrum of the tumor.

In some implementations, the present subject matter takes as input sequence data from matched tumor and normal DNA, following alignment of the data to a reference genome and standard preprocessing steps. Examples of the preprocessing steps can be found in DePristo, M. A. et al. A framework for variation discovery and genotyping using next-generation DNA sequencing data. Nature genetics 43, 491-498 (2011), the contents of which are incorporated herein by reference. In some implementations, the present subject matter operates on each genomic locus independently and includes (see FIG. 1):
(i) removal of low-quality sequence data, by applying several simple preprocessing filters to reads or read pairs (Online Methods);
(ii) variant detection in the tumor using a Bayesian classifier that distinguishes between a random sequencing error and a true variant (a base that is different from the reference genome);
(iii) a series of filters to remove false positives due to correlated sequencing artifacts not captured by the error model; and
(iv) a second Bayesian classifier to designate variants as somatic or germline.

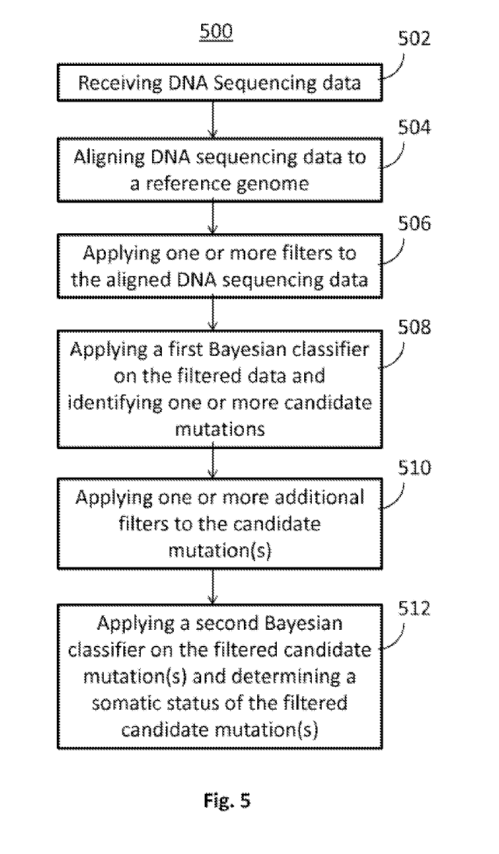

Reference is now being made to FIG. 5, which shows a process flow diagram illustrating an exemplary implementation of the present subject matter. The process flow 500 includes receiving DNA (e.g.) sequencing data at 502, aligning DNA sequencing data to a reference genome at 504, applying one or more filters to the aligned DNA sequencing data at 506, applying a first Bayesian classifier on the filtered data and identifying one or more candidate mutations at 508, applying one or more additional filters to the candidate mutation(s) at 510, and applying a second Bayesian classifier on the filtered candidate mutation(s) and determining a variant (somatic) status or classification of the filtered candidate mutation(s) at 512.

In some implementations, the present subject matter (MuTect) can take as input paired tumor and normal next generation sequencing data and, after removing low quality reads, determines if there is evidence for a variant beyond the expected random sequencing errors (variant detection will be discussed in more detail below). Candidate variant sites are then passed through, for example, one or more (including all) filters to remove sequencing and alignment artifacts:
(i) Proximal Gap filter rejects variants with neighboring insertion/deletion events suggesting locally misaligned reads;
(ii) Poor Mapping Region filter rejects sites where a large fraction of the reads are ambiguously mapped, as indicated by a mapping quality score of zero;
(iii) Clustered Position filter looks for correlation in the position of the mutant alleles within their reads, which often occurs when the alignment method misplaces a read and clips most, but not all, of the mismatching bases;
(iv) Strand Bias filter rejects sites where the distribution of strand observations of the mutant allele is biased as compared to the reference allele;
(v) Triallelic Site filter excludes sites where there appear to be at least three alleles at the site beyond what is expected by sequencing error suggesting a site not accurately modeled by the base quality scores;
(vi) Observed in Control filter uses sequencing data from the matched normal as control data to eliminate sites where the control sample has even slight evidence of the mutant allele.

Next, a Panel of Normals can be used to screen out remaining false positives caused by rare error modes only detectable using more samples. Finally, the somatic or germline status of passing variants is determined using the matched normal.

In some implementations, the present subject matter can take as input sequence data from matched tumor and normal DNA after alignment of the reads to a reference genome and preprocessing steps discussed above, which include, for example, marking of duplicate reads, recalibration of base quality scores and local realignment. The method operates on each genomic locus independently and consists of four key steps (FIG. 1): (i) Removal of low-quality sequence data (based on known methods); (ii) variant detection in the tumor using a Bayesian classifier; (iii) filtering to remove false positives resulting from correlated sequencing artifacts that are not captured by the error model; and (iv) designation of the variants as somatic or germline by a second Bayesian classifier.

### Variant Detection

In some implementations, variants in the tumor can be identified by analyzing the data at each site under, for example, two alternative models:
(i) a reference model M₀, which assumes there is no variant at the site and any observed non-reference bases are due to random sequencing errors; and
(ii) a variant model M^{m}_{f} which assumes the site contains a true variant allele m at allele fraction land also allows, as in M₀, for the possibility of sequencing errors. The allele fraction f is unknown and is estimated as the fraction of tumor reads that support m. This explicit modeling off instead of assuming a heterozygous, diploid event makes the present subject matter more sensitive than other methods. In some implementations, m can be declared to be a candidate variant if the log-likelihood ratio of the data under the variant and reference models—that is, the LOD score (log odds)—exceeds a predefined decision threshold that depends on the expected mutation frequency and the desired false positive rate (Online Methods). The choice of decision threshold can be used to control the tradeoff between specificity and sensitivity, as described by a Receiver Operating Characteristic (ROC) curve (FIG. 2a, dashed line). A fixed threshold of 6.3, for example, can be used for all results presented unless indicated otherwise. This threshold corresponds to a 10̂6.3:1 odds ration in favor of the reference model, which is reasonable because the frequency of mutations in many tumors is only 1-10 per Mb and thus the a priori odds of a site harboring a mutation may be as low as 1:10̂5 or 1:10̂6.

The LOD score is useful as a threshold for declaring the presence of mutations, as can be observed in the concordance of predicted sensitivity and measured sensitivity from the virtual tumor approach (FIG. 2a, solid grey line vs. dashed line). Nonetheless, the LOD score cannot be immediately translated into the probability that a variant is due to true mutation rather than to sequencing error because the LOD score is calculated under an assumption of independent sequencing errors and accurate read placement. As will be discussed below, these assumptions are incorrect and as a result, although direction application of the LOD score accurately estimates the sensitivity to detect a mutation, it can substantially underestimate the true false positive rate.

### Variant Filtering

To eliminate these additional false positives, six filters are provided herein (FIG. 1; Online Methods). Three filters address false positives due to read misalignment, and three filters address non-independent sequencing errors. In addition, a panel of normal samples can be used as controls to further eliminate both germline events and artifacts (Online Methods). By employing subsets of these filters, several versions of the method can be defined (FIG. 1):
(i) Standard (STD), which applies no filters and thus includes all detected variants;
(ii) High Confidence (HC), which applies the six filters and
(iii) High Confidence+Panel of Normals (HC+PON), which additionally applies the Panel of Normals filter.

These filters may be applied to the virtual tumors benchmark to compare the results with the calculations based on an independent sequencing error model and accurate read placement (FIG. 2a).

FIGS. 2a and 2b show the sensitivity as a function of sequencing depth and allelic fraction. As can be seen in FIG. 2a, sensitivity and specificity of the present subject matter for mutations with an allele fraction of 0.2, tumor depth of 30× and normal depth of 20× using various values of the LOD threshold (θ_{T}) (0.1≦θ_{T}≦100). Results using a model of independent sequencing errors with uniform Q35 base quality scores and accurate read placement (solid grey) are shown as well as results from the virtual tumor approach for the standard (STD, dashed green) and high-confidence (HC, solid green) configuration. A typical setting of θ_{T}=6.3 is marked with black dots.

FIG. 2b shows Sensitivity as a function of tumor sequencing depth and allele fraction (indicated by color) using θ_{T}=6.3. The calculated sensitivity using a model of independent sequencing errors and accurate read placement with uniform Q35 ase quality scores (solid lines) are shown as well as results from the virtual tumor approach (circles) and the downsampling of validated colorectal mutations (diamonds). Error bars represent 95% CIs.

As can be seen, the sensitivity of the method is similar as estimated by the calculation and the virtual tumor benchmark both with (HC) and without (STD) filters. This demonstrates that the model is accurate with respect to detection and that the filters do not adversely impact sensitivity. Although, as observed, there is a large discrepancy in the false positive rates between the benchmark without filters (STD) and the calculation. After applying the filters (HC) specificity increases and closely follows the calculations, suggesting that the filters have largely eliminated false positives due to dependent sequencing errors and inaccurate read placement. This allows the detection threshold to be set, assuming an independent model of sequencing error and accurate read placement to produce, for example, a false positive rate of 0.5/mb.

### Variant (Somatic) Classification

Finally, each variant detected in the tumor is designated as somatic (not present in the matched normal), germline (present in the matched normal) or variant (present in the tumor, but indeterminate status in the matched normal due to insufficient data). To perform this classification, a LOD score can be used that compares the likelihood of the data under models in which the variant is present (at 50% frequency) or absent in the matched normal (Online Methods). The power to make a germline classification given the data and threshold can be calculated. In some implementations, insufficient data for classification is declared if there is less than 95% power. In some implementations, public germline variation databases can be used as a prior probability of an event being germline.

### Sensitivity

As an example, these benchmarking methods can be further applied to further evaluate the sensitivity of our mutation detection method, with the different filtering options (STD, HC and HC+PON), to detect mutations as a function of sequencing depth and allelic fraction (FIG. 2b).
(1) The sensitivity can be calculated under a model of independent sequencing errors and accurate read placement using, for example, a statistical test given an allelic fraction; tumor sequencing depth; and assuming all bases have a fixed base quality score of Q35 (approximate mean base quality score in simulation data; Online Methods).
(2) To apply the down-sampling benchmark, 3,753 validated somatic mutations, stratified by allele fraction (median=0.28, range=0.07-0.94), in colorectal cancer [REF-TCGACOAD] with deep-coverage (≧100×) exome-capture sequencing downloaded from dbGAP (phs000178) can be used.
(3) To apply the virtual tumor benchmark, deep-coverage data from two high coverage whole-genome samples (NA12878 and NA12981) sequenced on Illumina HiSeq instruments by the 1000 Genomes Project and another previous study, across 1 Gb of genomic territory can be used. (Note: the Panel of Normals filter (HC+PON) may not be used in the virtual tumor sensitivity benchmark because it discards common germline sites.)

Sensitivity estimates based on these approaches were highly consistent with each other (median coefficients of variation for each depth of 3.1%). This suggests that the benchmarking approaches accurately estimate the sensitivity of mutation calling methods, and also that the calculated sensitivity is robust across a large range of parameter values, thus enabling one to confidently extrapolate to higher depths and lower allele fractions.

Based on this analysis, it can be observed that the present subject matter is a highly sensitive detection method. It can detect mutations, for example, at a site with 30× depth in the tumor (typical of whole genome sequencing) and an allele fraction of 0.2 with 95.6% sensitivity. The sensitivity can be increased to 99.9% by sequencing deeper (e.g., to a depth of 50×), and drops to, e.g., 58.9% for detecting mutations with allelic fraction of 0.1 (at 30×) (FIG. 2b). Furthermore, with 150× depth (typical of exome capture sequencing depth), the present subject matter can have, e.g., 66% sensitivity for 3% allele fraction events. It is this sensitivity to detect low-allele fraction events that uniquely positions the present subject matter to analyze samples with low purity or with complex subclonal structure.

This detailed understanding of the factors determining sensitivity is critical for targeting the appropriate depth of sequencing. Because the allelic fraction of a mutation depends on the tumor purity, local copy-number and clonality, one can calculate the sequencing depth required to obtain a desired sensitivity on a tumor-specific basis. Also, given a sequencing data set, the present subject matter can calculate the sensitivity to have detected a mutation with a particular allelic fraction for each base along the genome. This allows the present subject matter to assert the absence of a mutation (with a specified allele fraction), which is particularly important in a clinical setting.

Specificity

It is trivial to create an extremely sensitive somatic mutation detection method by identifying any site with a single non-reference read as a candidate mutation. Clearly, such an approach would have an enormous false positive rate. Therefore in evaluating the performance of a mutation detection method, it is critical to thoroughly characterize its specificity. There are two sources of false positives:

(i) over-calling events in the tumor; and

(ii) under-calling true germline events in the matched normal.

Over-calling in the tumor is typically due to sequencing errors and inaccurate read placements whereas under-calling of true germline events in the matched normal is often due to low sequencing depth in the normal.

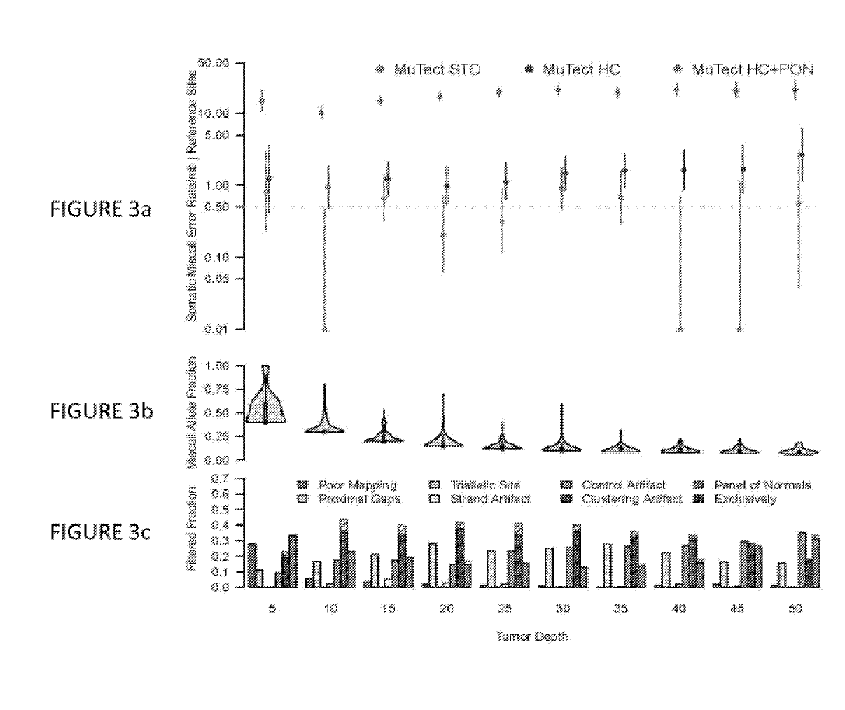

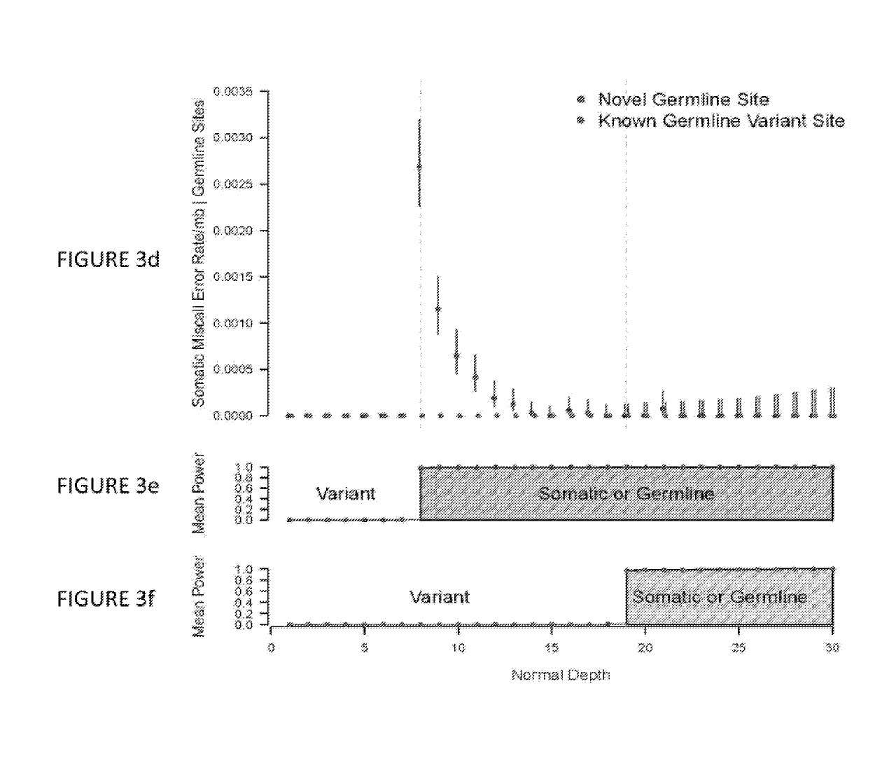

To measure the false positive rate due to over-calling in the tumor, the virtual tumor approach can be used, for example, across 1 Gb of NA12878 at various depths in the virtual tumor and at 30× in the virtual normal. All detected events are false positives, but to eliminate those due to under-calling germline events from consideration, we excluded all known germline variant sites. Using no filters (STD) the false positive rate increased with depth (from 6.7/mb at 5× to 20.1/mb at 30×) (FIG. 3a). This is due to the increased power to call mutations with lower allele fractions, which are enriched with false positives (FIG. 3b). The HC filters reduce the false positive rate by an order of magnitude (1.00/mb at 30×). The Panel of Normals (HC+PON) then filters out remaining rare, but recurrent, artifacts (0.51/mb at 30×). Certain filters, such as the Poor Mapping filter, have the biggest effect at low depths whereas other filters are more invariant to depth, such as the Proximal Gap filter (FIG. 3c). The Clustered Position filter rejects the most sites exclusively. However, the majority of false positives are rejected by several filters.

As can be seen, all detected events are false positives, but to eliminate those due to under-calling germline events from consideration, all known germline variant sites can be excluded. Using no filters (STD) the false positive rate increased slowly with depth (from 10/mb at 5× to 20/mb at 50×) (FIG. 3a). This is due to the increased power to call mutations with lower allele fractions, which are enriched with false positives (FIG. 3b). Note that this rate is well above the expected rate of 0.5/mb (grey dashed line) as set in the variant detection statistical test, which assumes an independent error model and accurate read placement. The filters (HC) specifically address these additional errors and reduce the false positive rate by an order of magnitude (from 21.3/mb to 0.90/mb at 30× tumor depth). The Panel of Normals (HC+PON) then filters out remaining rare, but recurrent, artifacts. Certain filters, such as the Poor Mapping filter, have the biggest effect at low depths whereas other filters are more invariant to depth, such as the Proximal Gap filter (FIG. 3c). The Clustered Position filter rejects the most sites exclusively, although multiple filters reject the majority of false positives.

The errors owing to under-calling of true germline events in the matched normal with the same approach but instead using the ˜1 million germline variant loci in the same territory (FIG. 3d-f). In classifying an event as germline or somatic, MuTect uses different prior probabilities at sites of common germline variation versus the rest of the genome, and therefore we report the false positive rates separately for these two scenarios (FIG. 3d) along with the power to have classified such events (FIG. 3e-f). We observe that with ≦7 reads in the normal at novel germline sites (FIG. 3e) or with ≦18 reads at sites of known germline variation (FIG. 3f), there is insufficient data to classify a variant as being somatic or germline, and hence we keep such sites as ‘variant’ and never make false positive somatic calls in these cases. Once there is sufficient data to make a classification, the error rate drops rapidly from 2.4×10⁻³ at 8× in the normal to below 0.2×10⁻³ at 12×, which corresponds to less than one misclassified germline in the entire exome (˜30 mb in the exome×50 novel germline variants/mb×0.2×10⁻³ error rate ˜30 mb in the exome×50 novel germline variants/mb×0.2×10⁻³ error rate).

Finally, the present subject matter has been used in several recent studies and was found to have a consistent validation rate of ˜95% in coding regions based on multiple orthogonal validation technologies (Table 2). Studies used earlier versions of the present subject matter, which were less sensitive. However a recent publication using this version was able to detect mutations present at 7% allelic fraction (8 reads out of 102) which were subsequently validated by ultra-deep sequencing (˜6,000×). In fact, the validation rate is not the best measure for comparing false positive rates across studies because it depends on the ratio of false positive to true mutations, which varies across tumor types. We therefore also report the false positive rate itself (Table 2). We observe a median false positive rate of 0.16/Mb, which is lower than the rate we report using whole genome data (FIG. 3) but consistent with the rate measured when restricting to coding regions, indicating that coding regions are less prone to sequencing and alignment errors.

In some implementations, false positives can be further reduced by taking each read in the tumor and normal, and realigning them to a reference genome with stringent alignment settings. The resulting alignments can be re-processed by the present subject matter to see if enough evidence for the mutation exists after considering the more stringent alignments.

### Comparison to Other Methods

The down-sampling and virtual tumor benchmarking approaches were used to compare the present subject matter against other commonly used methods: SomaticSniper, JointSNVMix, and Strelka. Each method was tested in two configurations, standard (STD) and high confidence (HC), with thresholds chosen to produce similar false positive rates across the methods. For SomaticSniper (v1.0.0), the published configurations was used, and for JointSNVMix (v0.7.5) a detection threshold of P(Somatic)≧0.95 for STD and P(Somatic)≧0.9998 for HC was used. For Strelka (v0.4.7) the recommended configuration with a quality score ≧15 for HC and ≧1 for STD was used.

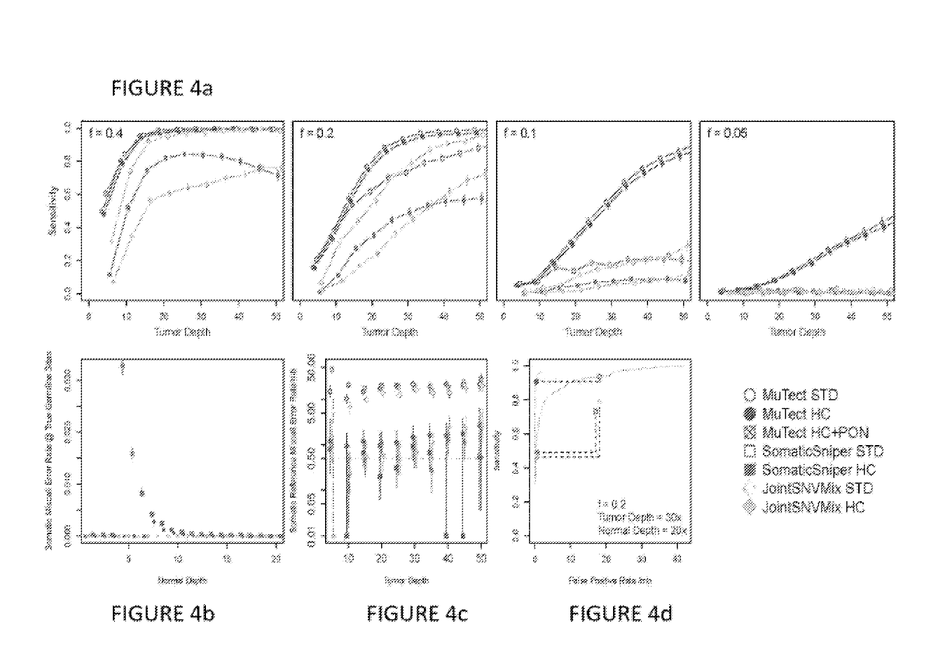

FIGS. 4a-4d show the benchmarking mutation detection methods. Specifically, the sensitivity of the methods was evaluated with regard to allele fraction and tumor sequencing depth using the virtual tumor (FIG. 4a) and down-sampling approaches, and a sharp distinction in sensitivity was observed, particularly at lower allele fractions. Data were analyzed for 30× sequence coverage. In the standard configurations, all methods show ≧99.3% sensitivity for mutations at an allele fraction of 0.4. However, in the HC configurations, the present subject matter, JointSNVMix and Strelka remain sensitive, 98.8%, 96.6% and 98.5% respectively, whereas SomaticSniper drops to 91.5%. At an allele fraction of 0.1, the present subject matter HC can detect more than half of the mutations (53.2%), whereas Strelka HC detects only 29.7%, JointSNVMix HC drops to 16.8% and SomaticSniper HC falls to 7.4%. At an even lower allele fraction of 0.05, the present subject matter HC has 16.0% sensitivity but can be increased to 51.9% with 60× coverage. By contrast, JointSNVMix HC and SomaticSniper HC have a sensitivity of ≦2.0%, and the sensitivity does not increase appreciably with tumor sequencing depth. Strelka HC detects just 4.6% of the events at 30× and only increases to 20.8% at 60×. Sensitivity for such low allelic fraction events is critical for characterizing impure tumors or subclonal mutations in heterogeneous tumors, and it appears that the present subject matter is much more sensitive in this regime.

As a more sensitive method may also be less specific, the performance of the methods with regard to the two kinds of false positives was compared. To this end, a very low false positive rate was observed due to miscalled germline sites for all methods given sufficient depth (≧15×) in the matched normal (FIG. 4b). The false positive rates per megabase owing to miscalled reference sites (FIG. 4c) are comparable above 20× in both the STD configuration (median=10.2, range=0.7-20.1) and the HC configuration (median=1.0, range=0.2-3.1).

The tradeoff between sensitivity and specificity for each of the methods can be summarized using a ROC curve, which depends on the sequencing depths in the tumor and normal and the mutation allele fraction. FIG. 4d gives an example using tumor depth of 30×, normal depth of 30× and allele fraction of 0.1, showing that the present subject matter is a generally more sensitive for a given specificity and also has a much smaller decrease in sensitivity for a similar increase in specificity gained by the HC configuration (dashed lines).

The sensitivity of the methods was compared using previously reported sequencing data and validated mutations in the COLO-829 melanoma cell line. Although the present subject matter is slightly more sensitive than the other methods, this dataset represents a pure cell line with easily detectable high allelic fractions events (median=0.55) and thus does not expose differences between methods. By using the present subject matter and the other mutation callers, additional mutations not originally reported can be found, underscoring that comparisons to mutations reported in the literature typically underestimate the sensitivity as the complete ground truth set of somatic mutations is often unknown.

As new somatic mutation callers are developed the cancer genome community will greatly benefit from a systematic performance measurement using the approaches described here across the entire parameter space of tumor and normal depths and mutation allele fraction. The approaches described herein can also be extended in the future to other alterations such as indels or rearrangements. The cancer genome community is eager to adopt new and improved methods but require detailed performance characterization in order to decide their optimal working point along the ROC curve.

Our data suggest that the present subject matter has an advantage over other methods in terms of its tradeoff between specificity and sensitivity (FIG. 4). One advantage in sensitivity of the present subject matter is derived from the variant detection statistical test, which includes an estimation of the allele fraction of the event, and the working point chosen along the ROC curve. SomaticSniper and JointSNVMix use a model based on a clonal mutation in a pure, diploid tumor (and thus assume a fixed 50% allele fraction). This assumption reduces sensitivity for lower allele fraction events. In contrast, Strelka specifically considers allele fraction, and thus in the STD configuration has similar sensitivity to the present subject matter. However, when running in the recommended HC configurations to control false positives, the present subject matter has only a minor drop in sensitivity compared with the other methods. This is likely because the filters in the present subject matter were carefully tuned to reject true false positive calls without sacrificing sensitivity.

The present subject matter is shown to be much more sensitive at a given specificity than competing methods, allowing one to more comprehensively characterize the landscape of somatic mutations, particularly those present in a small fraction of cancer cells. Moreover, this can be done with standard sequencing depths enabling analysis of the large datasets that are being generated worldwide. Analysis of subclonal mutations and changes in the fractions of cancer cells which harbor them is a powerful way to study the evolution of subclones as they progress during treatment, metastasis and relapse. In particular, we demonstrated that the presence of subclonal mutations in genes involved in driving chronic lymphocytic leukemia (CLL) is an independent prognostic factor beyond the currently used clinical parameters. In fact, using standard exome sequencing data, we were able to detect mutations present in as low as 10% of cancer cells, representing an expected allele fraction of 0.05 (assuming a heterozygous mutations in a diploid region) even before accounting for stromal contamination, which appear to have an effect on time to therapy.

Because the existing methods were not as sensitive to low allelic fraction events, they may miss important subclonal drivers of progression or resistance. Therefore, the sensitivity of the present subject matter to detect subclonal mutations with low allele-fractions represents a substantial advance, essential to future discoveries regarding the subclonal architecture of cancer and the translation of those discoveries into clinical diagnostics affecting cancer patient treatment and outcomes.

### FIGURE LEGENDS

FIG. 1 is an overview of somatic point mutation detection using the present subject matter. The present subject matter takes as input tumor (T) and normal (N) next generation sequencing data and, after removing low quality reads, determines if there is evidence for a variant beyond the expected random sequencing errors. Candidate variant sites are then passed through six filters to remove artifacts (Table 1). Next, a Panel of Normals can be used to screen out remaining false positives caused by rare error modes only detectable in additional samples. Finally, the somatic or germline status of passing variants is determined using the matched normal.

FIG. 2 shows sensitivity as a function of sequencing depth and allelic fraction.
(a) Sensitivity and specificity of the present subject matter for mutations with an allele fraction of 0.2, tumor depth of 30× and normal depth of 30× using various values of the LOD threshold (θ_{T}) (0.1≦θ_{T}≦100). Results using a model of independent sequencing errors with uniform Q35 base quality scores and accurate read placement (solid grey) are shown as well as results from the virtual tumor approach for the standard (STD, dashed green) and high-confidence (HC, solid green) configurations. A typical setting of θ_{T}=6.3 is marked with black circles.
(b) Sensitivity as a function of tumor sequencing depth and allele fraction (indicated by color) using θ_{T}=6.3. The calculated sensitivity using a model of independent sequencing errors and accurate read placement with uniform Q35 base quality scores (solid lines) are shown as well as results from the virtual tumor approach (circles) and the downsampling of validated colorectal mutations (diamonds). Error bars represent 95% CIs.

FIG. 3 shows specificity of variant detection and variant classification using virtual tumor approach. (a) Somatic miscall error rate for true reference sites as a function of tumor sequencing depth for the STD (red), HC (blue) and HC+PON (green) configurations of the present subject matter. Error bars represent 95% CIs. (b) Distribution of allele fraction for all miscalls as a function of tumor sequencing depth. (c) Fraction of events rejected by each filter; hashed regions indicate events rejected exclusively by each filter. (d) Somatic miscall error rate for true germline SNP sites by sequencing depth in the normal when the site is known to be variant in the population (blue) and novel (red). Error bars represent 95% CIs. (e,f) Mean power as a function of sequencing depth in the normal to have classified these events as germline or somatic at novel germline sites (e) and known germline variant sites (f).

FIG. 4 shows benchmarking mutation detection methods. (a) Comparison of sensitivity as a function of tumor sequencing depth and mutation allele fraction for different mutation detection methods and configurations. (b) Comparison of somatic miscall error rate for true germline sites as a function of sequencing depth in the normal. (c) Comparison of somatic miscall error rate for true reference sites as a function of tumor sequencing depth. (d) Sensitivity as a function of specificity for mutations with an allele fraction of 0.1, tumor depth of 30× and normal depth of 30× between different methods and configurations. Black dotted lines indicate change in sensitivity and specificity between STD and HC configurations for a method. Grey solid lines are the results of virtual tumor approach. (a-c) Error bars represent 95% CIs.

The “Online Methods” discussed above include:
Short Read Preprocessing:
   Reads are preprocessed differently according to how they will be used: detection of the variant in the tumor, discovery of an artifact in the normal or for somatic classification.
For discovery of the variant in the tumor, only the highest quality data should be used in order to eliminate false positives. Therefore only reads that pass the following tests are retained:
   (a) Mapping Quality score ≧1
   (b) Base quality score ≧5
   (c) If there is an overlapping read pair, and both reads agree the read with the highest quality score is retained otherwise both are discarded.
   (d) Sum of the quality scores of the mismatches ≦100
   (e) <30% of bases have been soft-clipped
   (f) Reads that have not been mapped by “mate rescue” of BWA (BAM XT tag !=“M”)

When looking at the matched normal control to discover systematic artifacts, a less stringent set of filters are applied in order to more readily detect these artifacts. These reads must pass the following tests:
(a) Mapping Quality score ≧1
(b) Base quality score ≧5
(c) If there is an overlapping read pair, and both reads agree the read with the highest quality score is retained otherwise the read that disagrees with the reference is retained.

Variant Detection:
For each site we denote the reference allele as rεA, and denote by bᵢ and eᵢ the called base of the i-th read (i=1 . . . d) that covers the site and the probability of error of that base call (each base has an associated Phred-like quality score qᵢ where

$${e}_{i} = {10}^{- \frac{{q}_{i}}{10}} ) .$$

To call a variant in the tumor we try to explain the data using two models:
   (i) a model, M₀, in which there is no variant at the site and all non-reference bases are explained by sequencing noise; and
   (ii) a model, Mₘ^{f}, in which a variant allele m truly exists at the site with an allele fraction f and, as in M0, reads are also subject to sequencing noise. Note that M₀ is equivalent to Mₘ^{f} with f=0.

The likelihood of the model Mₘ^{f} is given by

L[M_{f}^{m}]=P([bᵢ]|{eᵢ},r,m,f)=Πᵢ₌₁^{d}P(bᵢ|eᵢ,r,m,f)

assuming the sequencing errors are independent across reads. If all substitution errors are equally likely, i.e. occur with probability eᵢ/3, we obtain

$$P ( \{ {b}_{i} \} \vert \{ {e}_{i} \} , r , m , f ) = \{ \begin{matrix}f \frac{{e}_{i}}{3} + ( 1 - f ) ( 1 - {e}_{i} ) & if {b}_{i} = r \\ f ( 1 - {e}_{i} ) + ( 1 - f ) \frac{{e}_{i}}{3} & if {b}_{i} = m \\ \frac{{e}_{i}}{3} & otherwise\end{matrix}$$

Variant detection is performed by comparing the likelihood of both models and if their ratio, i.e. the LOD score (log odds) exceeds a decision threshold (log₁₀ δ_{T}), then m can be declared as a candidate variant at the site. LOD_{T} can be calculated:

$${LOD}_{T} = {log}_{10} ( \frac{L [ {M}_{f}^{m} ] P ( m , f )}{L [ {M}_{0} ] ( 1 - P ( m , f ) )} ) \geq {log}_{10} {θ}_{T}$$

and set δT to 2 to ensure that we are at least twice as confident that the site is variant as compared to noise. LOD_{T} can be rewritten as:

$${LOD}_{T} = {log}_{10} ( \frac{L [ {M}_{f}^{m} ]}{L [ {M}_{0} ]} ) \geq {log}_{10} δ - {log}_{10} ( \frac{P ( m , f )}{( 1 - P ( m , f ) )} ) = {θ}_{T}$$

To determine P(m,f), we first assume that P(m) and P(f) are statistically independent, and that P(f) is uniformly distributed (i.e. P(f)=1) and P(m) is a ⅓ of the expected mutation frequency for the studied tumor type (representing equal prior for all substitutions). In practice, we use a typical mutation frequency of 3×10⁻⁶ which yields 0_{T}=6.3.

Finally, in order to set the unknown allelic fraction parameter f, a maximum likelihood estimation can be used, i.e. find f that maximizes LOD_{T}. However, for computational efficiency, estimate

$${\hat{f}}_{ML} as \hat{f} = \frac{\# of mutant reads}{\# of total reads}$$

can be used.

A common source of false positive mutation calls is contamination of the tumor DNA with DNA from other individuals. Germline SNPs in the contaminating DNA appear as somatic mutations. We have previously demonstrated that such contamination can yield a large number of false positives and developed a tool, ContEst²³ to estimate the contamination level, f_{cont}, in sequencing data. Low-level contamination of DNA is a common phenomenon and even 2% contamination can give rise to 166 false positive calls per megabase and 10/Mb when excluding known SNP sites²³. To protect against this type of false positives and enable analysis of contaminated samples, we replace the reference model with a variant model M^{m}_{fcont}. This guarantees that variants are called only when they are highly unlikely to be explained by contamination.

Variant Filters:

(1) Proximal Gap
This filter attempts to remove false positives caused by nearby misaligned small insertion and deletion events. In some implementations, the site can be rejected if there are ≧3 reads with insertions within an 11 bp window centered on the candidate mutation OR if there are ≧3 reads with deletions within the same 11 bp window.

(2) Poor Mapping
This filter attempts to remove false positives caused by sequence similarity in the genome by looking at the fraction of reads which have a mapping quality score of zero. Candidates are rejected of ≧50% of the reads in the tumor and normal have a mapping quality of zero.

(3) Triallelic Site
This filter attempts to reject false positives caused by calling tri-allelic sites where the normal is heterozygous with alleles A/B and the present subject matter is considering an alteration of allele C. Although this is biologically possible, and remains an area for future improvement in mutation detection, calling at these sites generates many false positives and therefore they are currently filtered out by default.

(4) Strand Bias
This filter attempts to reject false positives caused by context specific sequencing errors where the vast majority of the alternate alleles are observed in a single direction of reads. In some implementations, this test is performed by stratifying the reads by direction and then performing the core detection statistic on the data. However, in exon capture sometimes the reads are only present in one direction. Therefore we also must consider the sensitivity to have passed the threshold given the data shown using the same calculation we used to calculate sensitivity to detect mutations. An artifact on the negative strand is flagged at LOD_{Tpositive}<2.0 and sensitivity to have reached this threshold is ≧90%. An artifact on the positive strand is flagged when LOD_{Tnegative}≦2.0 and sensitivity to have reached this threshold is ≧90%.

(5) Clustered Position
This filter attempts to reject false positives caused by misalignments hallmarked by the alternate alleles being clustered at a consistent distance from the start or end of the read alignment. In some implementations, the method calculates the median and median absolute deviation of the distance from both the start and end of the read and reject sites that have a median ≦10 (near the start/end of the alignment) and a median absolute deviation ≦3 (clustered).

(6) Observed in Control
This filter attempts to eliminate false positives in the tumor by looking at the control data for evidence of the alternate allele beyond what is expected from random sequencing error. Considering the alternate alleles observed in the control data, a candidate is rejected if those alternate alleles (a) have a sum of quality scores >20 and (b) have ≧2 observations OR represent ≧0.03 of the reads in the control data.

### Panel of Normals

In order to further reduce false positives and miscalled germline events, a panel of normal samples can be employed as a screen. To process this panel of normals, the present subject matter can run on them as if they were tumors without matched normal and all artifact-processing disabled (--artifact_detection_mode). From this data, a VCF file is created for the sites that were identified by the present subject matter in two or more samples.

The choice of two is intended to address the possibility that one of the normal in the panel is the matched normal that is contaminated with its matched tumor (i.e. tumor-in-normal). In this case, rejection of this site would not be warranted.

This VCF can then supplied to the caller, which rejects these sites. However, if the site was present in the supplied VCF of known mutations (--cosmic) it is retained because these sites could represent known recurrent somatic mutations which have been detected in the panel of normal when the normal are from adjacent tissue or have some contamination tumor DNA.

The more normal samples used to construct this panel, the higher the power will be to detect and remove rare artifacts. Therefore, we typically we use all the normal samples readily available. The results presented here were obtained by using a panel of whole genome sequencing data from blood normals of 125 solid tumor cancer patients.

### Variant (Somatic) Classification

To perform this classification, we use a similar classifier to the one described above. In this case f in M_{f}^{m}, is conservatively set to 0.5 for a germline heterozygous variant. Thus:

$${LOD}_{T} = {log}_{10} ( \frac{L [ {M}_{0} ] P ( m , f )}{L [ {M}_{0.5}^{m} ] P ( germline )} ) \geq {log}_{10} {δ}_{N}$$

which can be rewritten as

$${LOD}_{N} = {log}_{10} ( \frac{L [ {M}_{0}^{m} ] P ( m , f )}{L [ {M}_{0.5}^{m} ] P ( germline )} ) \geq {log}_{10} {δ}_{N} - {log}_{10} ( \frac{P ( m , f )}{P ( germline )} ) = {θ}_{N}$$

Note that here the terms are inverted since we want to be confident that alteration was not present. For δ_{N}, a threshold of 10 can be set, which is higher than the threshold for δ_{N} so as to obtain more confidence in the somatic classification as misclassified germline events will quickly appear to be significant in downstream somatic analysis due to their elevated population frequency at recurrent sites as compared to real somatic events.

To calculate P (germline), two cases can be distinguished:

(i) sites which are known to be variant in the population; and

(ii) all other sites.

The public dbSNP database can be used to make this distinction.

There are ˜30×10⁶ sites known to be variant in the human population according to dbSNP release 134, which is ˜1000 variants/megabase. A given individual typically has 3×10⁶ variants in their genome, 95% of which fall on dbSNP sites. Therefore it is expected that ˜50 variants/mb not at dbSNP sites, i.e. P(germline|non-dbSNP site)=5×10-⁵ and therefore θ_{N|non-dbSNP site}=2.2 can be used. At dbSNP sites, however, it can be expected that 95% of the ˜3×10⁶ variants to occur in the 30×10⁶ sites in the dbSNP database, yielding P(germline|dbSNP site)=0.095 hence θ_{N|dbSNP site}=5.5.

### Virtual Tumor Benchmarking Approach

The virtual tumor approach begins with a high coverage (60×) whole genome sample sequenced by 1000 Genomes (NA12878). In some implementations, chromosome 20 is focused, as opposed to the entire genome, for computational efficiency.

The first step is to randomly divide the sequencing data in to several partitions. In some implementations, 12 partitions is created from the original 60× data, therefore creating data partitions with ˜5× each. This can be accomplished by sorting the BAM by name using SortSam from the Picard (http://picard.sourceforge.net) tools to effectively give the reads random ordering. Each read can be randomly allocated to one of the partitions and write it to a partition specific BAM file.

In order to measure specificity, certain partitions can be designated as the tumor and others as the normal and process them through the present subject matter. Any somatic mutations identified in this process are false positives as they are either germline events that are mis-sampled in the normal, or erroneous variants due to sequencing noise identified in the partitions designated as tumor. Because the present subject matter can accept multiple BAM files for each the tumor and normal, there is no need to merge the partitions a priori. However, because other methods do not have this capability the individual BAMs can also be merged.

In order to measure sensitivity, additional sequencing data on a second individual can be included. In some implementations, NA12891 can be used and sequenced to 60× as part of the 1000 Genomes Project. Using the published high confidence genotypes for those samples from the 1000 Genomes Project, a set of sites that are heterozygous in NA12891 and homozygous for the reference in NA12878 can be identified. In some implementations, a second utility, SomaticSpike, can also be used with MuTect to perform a mixing experiment in-silico. At each of the selected sites, this utility attempts to replace a specified fraction of reads drawn from a binomial distribution in the NA12878 data with reads from the NA12891 data therefore simulating a somatic mutation of known location and allele fraction. If there are not enough reads in NA12891 to replace the desired reads in NA12878 the site is skipped. The output of this process is a BAM with the in-silico variants and a set of locations of those variants. By attempting to detect mutations at these sites, the sensitivity can be estimated.

### Sensitivity Calculation

To calculate the sensitivity to detect a mutation with allelic fraction fusing n reads having a Phred-like quality score q (and hence a base error, e, of 10̂−(q/10)), first calculate k, the minimum number of reads with the alternate allele that will trigger a variant call using

k=argmin LOD_{T}(x|n,e)≧θ_{T}

The sensitivity is then the probability of observing k or more reads given the allelic fraction and depth. The marginal distribution of the number of reads with the alternate allele, either originating from the alternate base or a misread reference base, follows a binomial distribution with a frequency that reflects the true underlying allelic fraction f and the probability of error e (note that here, the worst case in which all misread based convert to the same alternate allele can be taken). Therefore, the probability of having observed k or more reads can be calculated as:

Σᵢ₌ₖⁿbinom(i|n,f(1−e)+(1−f)e)

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

TABLE 1
Description of variant filters and default thresholds

| Filter Name | Class | Description and Default Thresholds |
|---|---|---|
| Proximal Gap | HC | Remove false positives caused by nearby misaligned small insertion and |
| | | deletion events. Reject candidate site if there are ≧3 reads with |
| | | insertions within an 11-bp window centered on the candidate mutation, |
| | | or if there are ≧3 reads with deletions within the same 11-bp window |
| Poor Mapping | HC | Remove false positives caused by sequence similiarity in the genome, |
| | | leading to misplacement of reads. Two tests are used to identify such |
| | | sites: (i) Candidates are rejected if ≧50% of the reads in the tumor and |
| | | normal have a mapping quality of zero (although mapping quality zero |
| | | reads are discarded in the short-read preprocessing (Supplementary |
| | | Methods) this filter reconsiders those discarded reads; (ii) Candidates |
| | | are rejected if they do not have at least a single observation of the |
| | | mutant allele with a confident mapping (i.e. mapping quality score ≧20). |
| Triallelic Site | HC | Reject false positives caused by calling tri-allelic sites where the normal is |
| | | heterozygous with alleles A/B and MuTect is considering an alternate |
| | | allele C. Although this is biologically possible, and remains an area for |
| | | future improvement in mutation detection, calling at these sites |
| | | generates many false positives and therefore they are currently filtered |
| | | out by default. However, it may be desirable to review mutations failing |
| | | only this filter for biological relevance and orthogonal validation and |
| | | further study the underlying reasons for these false positives. |
| Strand Bias | HC | Reject false positives caused by context specific sequencing errors where |
| | | the vast majority of the alternate alleles are observed in a single |
| | | direction of reads. We perform this test by stratifying the reads by |
| | | direction and then applying the core detection statistic on the two |
| | | datasets. We also calculate the sensitivity to have passed the threshold |
| | | given the data (Online Methods). Candidates are rejected when the |
| | | strand specific LOD is <2.0 in directions where the senesitivity to have |
| | | passed the threshold is ≧90%. |
| Clustered Position | HC | Reject false positives caused by misalignments hallmarked by the |
| | | alternate alleles being clustered at a consistent distance from the start or |
| | | end of the read alignment. We calculate the median and median |
| | | absolute deviation of the distance from both the start and end of the |
| | | read and reject sites that have a median ≦10 (near the start/end of the |
| | | alignment) and a median absolute deviation ≦3 (clustered) |
| Observed in Control | HC | Eliminate false postives in the tumor by looking at the control data |
| | | (typically from the matched normal) for evidence of the alternate allele |
| | | beyond what is expected from random sequencing error. A candidate is |
| | | rejected if, in the control data, there are (i) ≧2 observations of the |
| | | alternate allele, or they represent ≧3% of the reads; and (ii) their sum of |
| | | quality scores is >20. |
| Panel of Normals | HC + PON | Reject artifacts and germline variants by inspecting a panel of normal |
| | | samples and rejecting candidates that are present in two or more normal |
| | | samples (Online Methods) |

TABLE 2
Published validation rates in coding regions

| | Mutation | | | | | |
|---|---|---|---|---|---|---|
| | rate/Mb | Validation | | | Validation | False positive |
| Tumor type | (**non-silent) | technology | Validated | Invalidated | rate | rate/Mb |
| Multiple Myeloma¹⁹ | 2.9 | Sequenom | 87 | 5 | 94.6% | 0.16 |
| Head and Neck⁴ | 3.3 | Sequenom | 181 | 8 | 95.8% | 0.14 |
| Breast³ | 2.9 | Sequenom/PCR/45 | 464 | 27 | 94.5% | 0.16 |
| Prostate²⁴ | 1.4 | Sequenom | 219 | 10 | 95.6% | 0.06 |
| Colorectal²⁵ | 5.9 | Sequenom | 292 | 16 | 94.8% | 0.31 |
| CLL²⁶ | 0.9 | Sequenom | 66 | 5 | 93.0% | 0.06 |
| Medulloblastoma²⁷ | 0.4** | Fluidigm/PacBio | 19 | 0 | 100.0% | n/a (5 genes) |
| Prostate²⁸ | 0.9 | Sequenom | 253 | 26 | 90.7% | 0.08 |
| DLBCL²⁹ | 3.2** | Fluidigm/Illumina | 46 | 1 | 97.9% | n/a (6 genes) |
| TCGA Colorectal⁷ | 14 | PCR/454 | 5,713 | 420 | 93.1% | 0.96 |
| Lung Adeno³⁰ | 12 | Capture/Illumina | 9,458 | 374 | 96.2% | 0.46 |

Although the present invention and its advantages have been described in detail, it should be understood that various changes, substitutions and alterations can be made herein without departing from the spirit and scope of the invention as defined in the appended claims.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. A method for detecting one or more variants from sequencing data, the method comprising:
receiving aligned sequencing data;
applying one or more filters to the aligned sequencing data;
using the filtered data as input, applying a first classifier to determine if any alteration is present beyond an expected threshold due to a sequencing error and identifying one or more candidate variants;
passing the one or more identified candidate variants through one or more additional filters to remove one or more false positives; and
determining a somatic status of the one or more filtered candidate variants using a second classifier,
wherein at least one of the above is performed by at least one data processor.

2. A method according to claim 1, wherein the one or more variants are mutations.

3. A method according to claim 2, wherein the mutations are point mutations.

4. A method according to claim 3, wherein the point mutations are somatic or germline point mutations.

5. A method according to claim 1, wherein the one or more false positives are created by correlated sequencing noise.

6. A method according to claim 1, wherein a Panel of Normals is used to identify one or more false positives.

7. A method according to claim 1, wherein the sequencing data comprises DNA sequencing or RNA sequencing data.

8. A method according to claim 1, wherein at least one of the first and second classifiers is a Bayesian classifier.

9. A method according to claim 1, wherein the one or more filters include a proximal gap filter which rejects variants with neighboring insertion and/or deletion events.

10. A method according to claim 1, wherein the one or more filters include a poor mapping region filter which rejects sites having a determined mapping quality score of zero.

11. A method according to claim 1, wherein the one or more filters include a clustered position filter which looks for correlation in the position of mutant alleles within their reads.

12. A method according to claim 1, wherein the one or more filters include a strand bias filter which rejects sites where a distribution of strand observations of mutant allele is biased compared to the allele of the reference genome.

13. A method according to claim 1, wherein the one or more filters include a triallelic site filter which excludes sites each having at least three alleles beyond what is expected by sequencing error.

14. A method according to claim 1, wherein the one or more filters include an observed in control filter which uses sequencing data from a matched normal as control data to eliminate sites where the reference genome has evidence of mutant allele.

15. A non-transitory computer readable medium comprising computer-executable instructions recorded thereon for causing a computer to perform the method according to claim 1.

16. A system for detecting one or more variants from sequencing data, the system comprising:
means for receiving aligned sequencing data;
means for applying one or more filters to the aligned sequencing data;
means for using the filtered data as input, applying a first classifier to determine if any alteration is present beyond an expected threshold due to a sequencing error and identifying one or more candidate variants;
means for passing the one or more identified candidate variants through one or more additional filters to remove one or more false positives; and
means for determining a somatic status of the one or more filtered candidate variants using a second classifier.

17. A method for benchmarking performance of variant detection, comprising:
providing variants that were discovered in deep-coverage sequencing data sets;
down-sampling by randomly excluding a subset of reads of the sequencing data set at sites of known validated variants; and
repeating the down-sampling one or more times and estimating a sensitivity as a fraction of the times the known variants are detected;
wherein at least one of the above is performed by at least one data processor.

18. A method for benchmarking performance of mutation detection, comprising:
creating a normal virtual tumor that has no true variants;
providing sequence data from a single normal sample;
assigning reads of the sequence data to be either “tumor” or “normal” to a desired depth; and
measuring a specificity by comparing the normal virtual tumor against the sequence data;
wherein at least one of the above is performed by at least one data processor.
